(19) United States
(12) Patent Application Publication
(10) Pub. No.: US 2024/0159941 A1
(43) Pub. Date: May 16, 2024

(54) ANTI-REFLECTIVE COATINGS ON OPTICAL WAVEGUIDES

(71) Applicant: Magic Leap, Inc., Plantation, FL (US)

(72) Inventors: Christophe PEROZ, San Francisco, CA (US); Kevin MESSER, Ft. Lauderdale, FL (US)

(73) Assignee: Magic Leap, Inc., Plantation, FL (US)

(21) Appl. No.: 18/419,183

(22) Filed: Jan. 22, 2024

Related U.S. Application Data
(63) Continuation of application No. 17/650,188, filed on Feb. 7, 2022.
Application No. 17/650,188 is a continuation of application No. 16/214,575, filed on Dec. 10, 2018, now Pat. No. 11,280,937.
(60) Provisional application No. 62/751,240, filed on Oct. 26, 2018.
(60) Provisional application No. 62/596,904, filed on Dec. 10, 2017.

(51) Int. Cl. G02B 1/115; F21V 8/00; G02B 27/01

(52) U.S. Cl. CPC G02B 1/115; G02B 6/0026; G02B 6/005; G02B 6/0076; G02B 27/0172; G02B 2005/1804; G02B 6/0065

(57) ABSTRACT

An anti-reflective waveguide assembly comprising a waveguide substrate having a first index of refraction, a plurality of diffractive optical elements disposed upon a first surface of the waveguide and an anti-reflective coating disposed upon a second surface of the waveguide. The anti-reflective coating preferably increases absorption of light through a surface to which it is applied into the waveguide so that at least 97 percent of the light is transmitted. The anti-reflective coating is composed of four layers of material having different indices of refraction that the first index of refraction and an imaginary refractive index less than 1×10⁻³ but preferably less than 5×10⁻⁴.

### CROSS-REFERENCE TO RELATED APPLICATIONS

This application is a continuation of U.S. patent application Ser. No. 17/650,188, filed on Feb. 7, 2022, which is a continuation of U.S. patent application Ser. No. 16/214,575, filed on Dec. 10, 2018 now U.S. Pat. No. 11,280,937, which claims priority from U.S. Provisional Patent Application No. 62/751,240, filed on Oct. 26, 2018, and U.S. Provisional Patent Application No. 62/596,904, filed on Dec. 10, 2017, all of which are incorporated herein by reference in their entirety.

### BACKGROUND OF THE INVENTION

Surface treatments of substrates such as windows or photovoltaic devices (e.g. solar energy panels) benefit from a coating of layered anti-reflective material. Reduction of glare from light impacting glass, improved retention of natural light for energy costs, or increased absorption of light impacting a photovoltaic cell are some of the ways anti-reflective coatings are used. Conventional anti-reflective coatings provide benefits for substantially orthogonal light paths, relative to normal of a surface of a substrate, but are generally directed to maximize anti-reflection for such freespace light that anticipates origination of light completely external to a substrate. Conventional coatings also seek to increase transmission rates. Certain optical mediums manipulate light paths other than freespace origination, and antireflection coatings to optimize the performance of such mediums are needed.

### SUMMARY

Embodiments of the present invention are generally directed to specific materials and thicknesses of layers for anti-reflective coatings in optical waveguides. More specifically, the embodiments and techniques described herein relate to anti-reflective coatings that must facilitate light propagation for total internal reflection (TIR), and simultaneously minimize light reflection at orthogonal angles or other freespace light. Embodiments described herein are directed away from seeking complete transmission of light.

Some embodiments are directed to a waveguide substrate having a first index of refraction, such as glass. The substrate may be planar, or cylindrical (such as a fiber optic). For planar substrates, a plurality of diffractive optical elements, such as a grating, is disposed upon a first surface, and an anti-reflective coating is disposed upon the opposite surface. For cylindrical waveguides, an anti-reflective coating is applied to the outer surface.

In some embodiments, the waveguide is configured to receive light, and propagate it along an axis by total internal reflection. In planar waveguides, the light travels in along such an axis in a first direction, and outcouples light in a substantially orthogonal direction when the light reflects off of a diffractive optical element of that corresponding surface. In cylindrical waveguides, the light reflects along the waveguide along an axis substantially parallel to the length of the waveguides, and outcouples at a distal end.

The anti-reflective coating of such embodiments is configured to minimize the phase retardation as between the s and p polarization states of the received light, such that the angle of bounce by TIR for each polarization component of light is substantially similar.

In some embodiments, the anti-reflective coating is a single layer of magnesium fluoride (MgF₂) having a thickness between 75 and 125 nanometers (nm). In some embodiments, a layer of silica (SiO₂) is applied as an outer layer to the coating.

In some embodiments, the anti-reflective coating has an imaginary refractive index value (alternatively referred to herein as an absorption coefficient), k, less than 5×10⁻⁴. In some embodiments the k value of the complete coating is between 5×10⁻⁴ and 1×10⁻³, regardless of the number of layers comprising the coating. In some embodiments, the coating is a single layer of material. In some embodiments, the coating alternates between two materials, with one material having a comparatively higher index of refraction than the second material. In some embodiments, less than eight total layers are utilized.

In some embodiments, titania (TiO₂) with an index of refraction greater than 2 is utilized as a coating layer material; in some embodiments, SiO₂ with an index of refraction between 1.45 and 1.58 alternates layers with titania.

These materials and layer selections optimize the efficiency of light output by an optical waveguide, minimize phase retardation to reduce optical defects such as striations in images output by such a waveguide, and minimize the labor and material cost of conventional layers.

### BRIEF DESCRIPTION OF THE DRAWINGS

FIG. 1 is a top-down view showing an anti-reflective coating as understood with respect to its function to minimize reflected light and maximize absorption of light into a waveguide.

FIG. 2 is a top-down view showing a planar waveguide outcoupling a plurality of beams that propagate through the waveguide by total internal reflection according to some embodiments.

FIG. 3 is a top-down view showing a multi-waveguide stack outcoupling a plurality of beams as light bundles according to some embodiments.

FIG. 4 is a front view of a planar waveguide having three diffractive optical element regions according to some embodiments.

FIG. 5 is a front view showing an orthogonal pupil expander diffracting light across its span according to some embodiments.

FIG. 6A is a top-down view showing a plurality of light bounces through a waveguide according to some embodiments.

FIG. 6B is a front view of an inferometer network of energy transmitted through a waveguide configured to support total internal reflection according to some embodiments.

FIG. 7 is a graph illustrating a phase retardation relationship as a function of layers in an anti-reflective coating according to some embodiments.

FIG. 8A shows captured images of an eyepiece design for blue (455 nm) light on substrates with different n values of layers of an anti-reflective coating.

FIG. 8B shows simulated images of an eyepiece design for blue (455 nm) light on substrates with different n values of layers of an anti-reflective coating.

FIG. 8C shows captured images of an eyepiece design for red (625 nm) light on substrates with different n values of layers of an anti-reflective coating.

FIG. 8D shows simulated images of an eyepiece design for red (625 nm) light on substrates with different n values of layers of an anti-reflective coating.

FIGS. 9A-9D are graphs that illustrate efficiency decay of light energy output by a waveguide as a function of the number of layers and k value of an anti-reflective coating according to some embodiments.

### DETAILED DESCRIPTION

Antireflection coatings are generally configured to create out-of-phase reflections across layers of material with differing indices of refraction. Conventionally, single-layer anti-reflective coatings seek a refractive index, n, equal to the square root of the coated substrate's index of refraction, and with a thickness, t, equal to one quarter the wavelength, k, of the light targeted by the anti-reflective coating.

n_{coating}=√(n_{substrate}) Eq. 1

t=λ_{target light}/(4·n_{coating}) Eq. 2

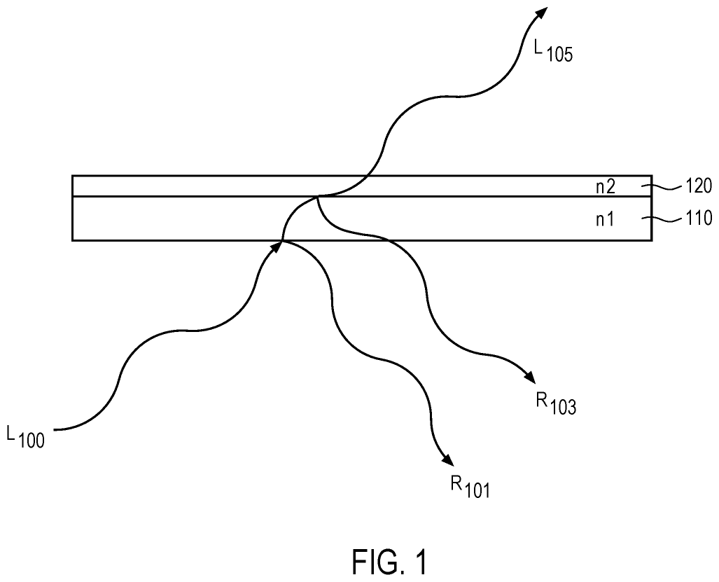

FIG. 1 depicts anti-reflection, with light L 100 impacting medium 110 and reflecting light R 101 while simultaneously transmitting to medium 120 and reflecting light R 103 that creates constructive interference with light R 101; remaining light L 105 transmits into medium 103. Many variations to improve the total amount of transmitted light L 105 are known. For example, broad band anti-reflection to improve transmission of multiple wavelengths with a single coating is achieved with additional and/or varying thickness layers.

Though the coating arrangement show in FIG. 1 may work as intended for freespace light, some optical systems employ waveguide technology; augmented or mixed reality system in particular maximize this technology in exit pupil expander systems to deliver light from a source and propagate that light through waveguides by TIR and then outcouple towards a user's eye.

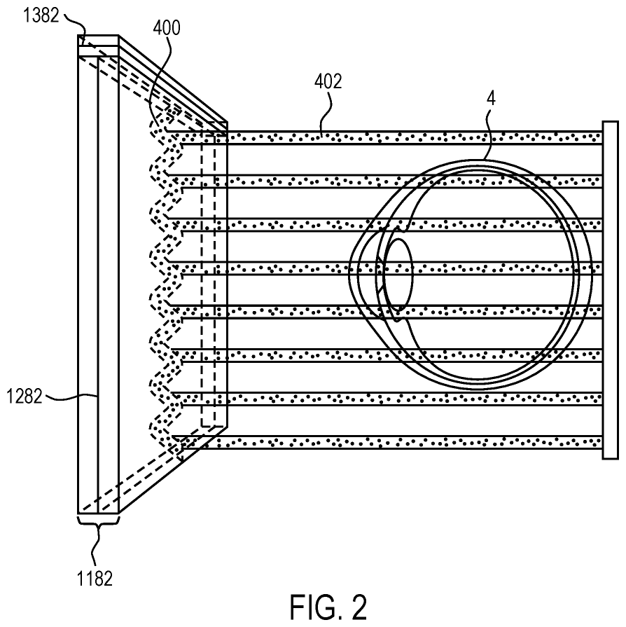

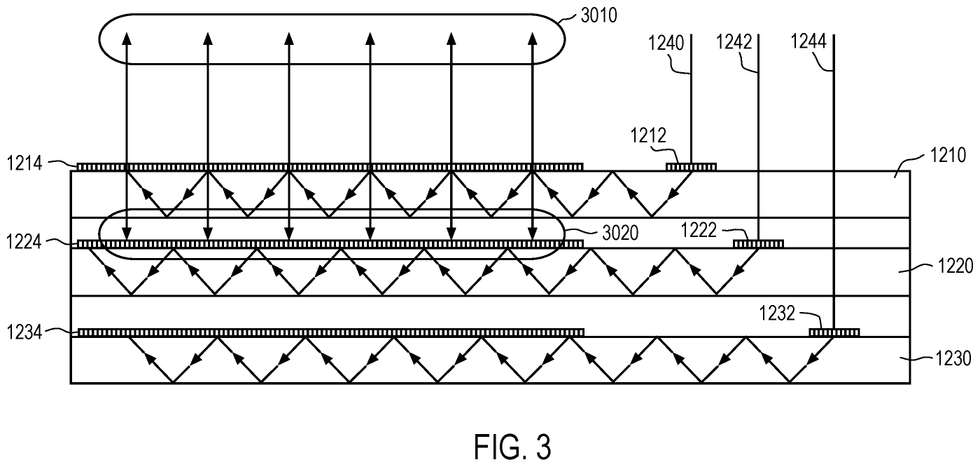

FIG. 2 shows a simplified version of such a system. One waveguide is illustrated, but it will be appreciated that other waveguides stacked together (as further described below with reference to FIG. 3) may function similarly. Light 400 is injected into the waveguide 1182 at an input surface 1382 of the waveguide 1182 and propagates within the waveguide 1182 by TIR. The input surface 1382 may be an incoupling grating formed by diffractive optical elements to diffract light 400 into the waveguide 1382 at angles supporting TIR. At points where the light 400 impinges upon outcoupling diffractive optical elements 1282, sampled portions exit the waveguide as a plurality of exit beams 402.

Each exit beam is a sampled beamlet of light 400 and increases the likelihood that any one sampled beamlet will be viewed by an eye 4 of a viewer. It is critical therefore that the waveguide 1182 maintains TIR to create the plurality of exit beams across its span, otherwise the exit beams 402 would not be distributed, and the resulting exit pupil(s) would only be viewable in certain positions of eye 4, limiting the applicability and flexibility of the system.

FIG. 2 depicts a single waveguide system, but one of skill in the art will appreciate that if single waveguide 1182 imparts sampled portions of light 400, additional waveguides performing similar functions may impart additional sampled portions to create rich light effects such as multi-color component images or depth perception. FIG. 3 illustrates such a multi-layered system with three waveguides 1210, 1220, and 1230 propagating light by TIR. As each light path 1240, 1242 and 1244 respectively incouples at locations 1212, 1222, and 1232 impact a respective outcoupling diffractive optical element 1214, 1224, or 1234 (outcoupled light from paths 1222 and 1232 not depicted) disposed upon waveguide 1210, 1220, and 1230, it diffracts a plurality of beamlets in two directions: one towards the viewer (as in eye 4 of FIG. 2) represented by light bundle 3010, and one in a direction away from the viewer represented by light bundle 3020.

The light bundle 3020 may cause undesirable effects if it reflects off of the subsequent waveguide 1220, such as interference with light bundle 3010, increased blurriness due to any change in angle that may result from the reflection, etc. Here, an anti-reflective coating applied to the opposite surface of a waveguide from its outcoupling diffractive optical element will be beneficial to reduce these effects. A conventional coating that attempts to increase transmission generally will, however, degrade the light paths 1240, 1242, and 1244 as they progress across waveguides 1210, 1220, and 1230 by TIR. This degradation introduces uniformity complications at outcoupling, and results in poor image quality.

Waveguide optical systems that employ pupil expander technology aggravate this problem. In a pupil expander system, such as depicted in FIG. 2, not only is light distributed in the substantially vertical direction, but also in an orthogonal direction to the exit beam path. FIG. 4 depicts an orthogonal pupil expander (OPE) 3706 disposed upon a waveguide 3704. FIG. 4 also depicts an exit pupil expander (EPE) 3708 for outcoupling progressive exit beams of TIR light, similar to outcoupling diffractive optical elements 1282 depicted in FIG. 2, and an incoupling grating (ICG) 3702 similar to the input surface 1382 of FIG. 2. In the waveguide system of FIG. 4, light incouples to the waveguide through the incoupling grating and diffracts towards the orthogonal pupil expander.

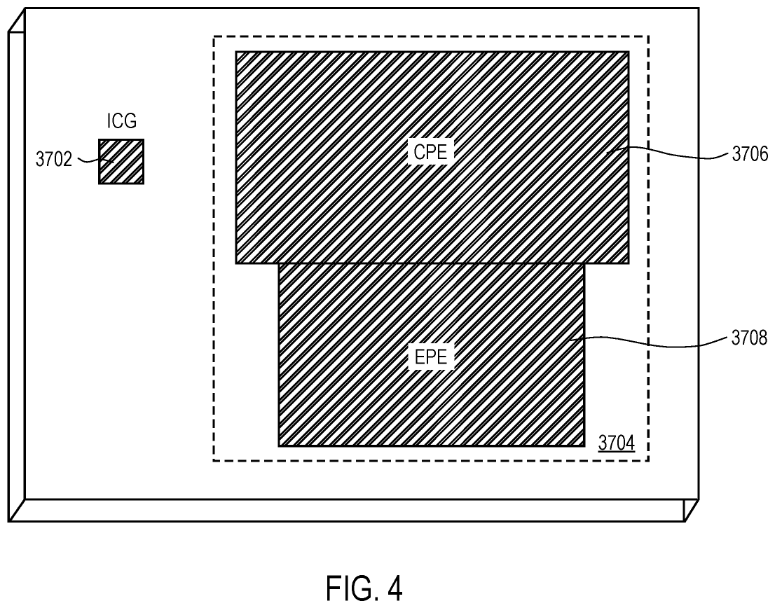

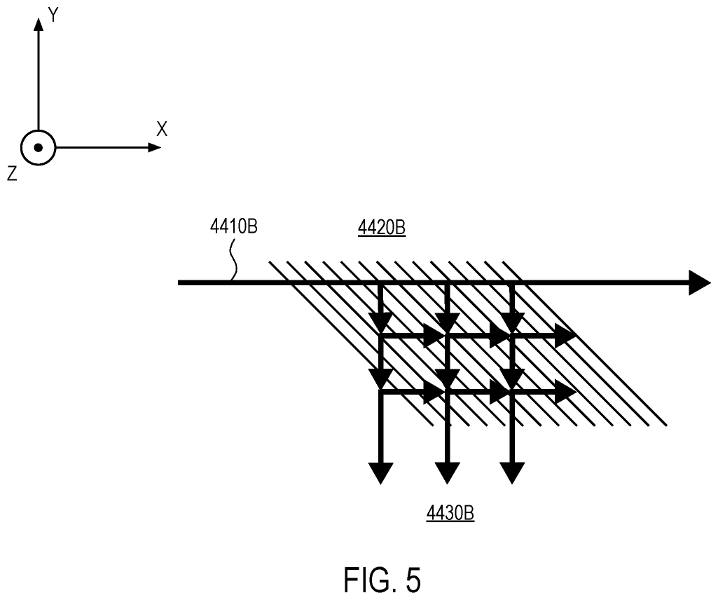

FIG. 5 depicts light sampling across the orthogonal pupil expander. Light 4410B from the incoupling grating of FIG. 4 encounters a grating 4420B, such as a series of diffractive optical elements, that diffracts samples of light in a first direction and a sample 4430B of that same light in a second direction; the particular directions diffracted are a function of the particular geometries of the diffractive optical element.

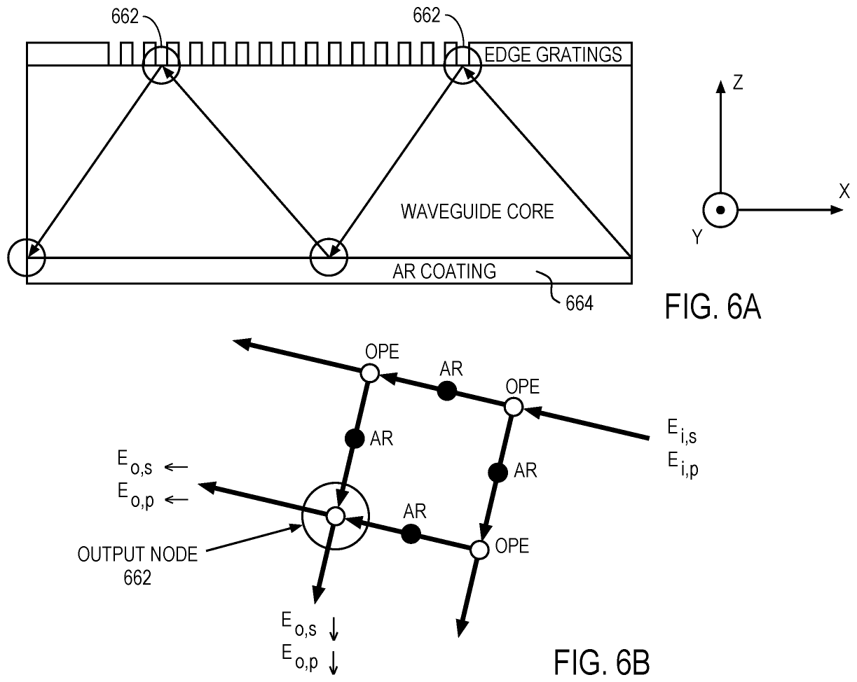

FIG. 6A depicts a cross-sectional view of this light path, one a waveguide comprising a grating 662 on one surface, and an anti-reflective coating 664 on the opposite surface. As light propagates by TIR through the waveguide, it alternatively reflects against the orthogonal pupil expander, and a surface opposite the orthogonal pupil expander. One of skill in the art will appreciate that a similar functionality occurs with the exit pupil expander region of the waveguide. To reduce the reflections described by light bundle 3020 in reference to FIG. 3, an anti-reflective coating is applied to this opposite surface. A cumulative light inferometer may be derived from this interaction, such as the unit cell inferometer depicted by FIG. 6B. In FIG. 6B, each interaction with the orthogonal pupil expander will sample the light into two paths, with a reflection against the anti-reflective coating side between each successive reflection against the orthogonal pupil expander. Each reflection off of the orthongonal pupil expander side or the anti-reflection side may further introduce polarization changes to the light, such that each successive bounce perturbs the polarization state and changes the energy at each output node.

By breaking down the polarization into the constituent s and p states, the resulting electric field, E, is a function of amplitude, A, and phase, ϕ, of the light, and is depicted for each s and p path as follows:

E_{i,s}=A_{i,s}e^{jϕ}^{_{i,s}} Eq. 3

E_{i,p}=A_{i,p}e^{jϕ}^{_{i,p}}Eq. 4

where i indicates the variables' value at input.

Each interaction (indicated by a directionality arrow below with correlation to the paths of the light at an output node of FIG. 6B) may be described as a 2×2 matrix multiplied by the energy of the s and p elements of Eq. 3 and Eq. 4. Such that

$$[ \begin{matrix}{E}_{o , s ↓} \\ {E}_{o , p ↓}\end{matrix} ] = [ \begin{matrix}\sqrt{{η}_{s ↓ s ←}} {e}^{j {ϕ}_{s ↓ s ←}} & \sqrt{{η}_{s ↓ p ←}} {e}^{j {ϕ}_{s ↓ p ←}} \\ \sqrt{{η}_{p ↓ s ←}} {e}^{j {ϕ}_{p ↓ s ←}} & \sqrt{{η}_{p ↓ p ←}} {e}^{j {ϕ}_{p ↓ p ←}}\end{matrix} ] [ \begin{matrix}{E}_{i , s ←} \\ {E}_{i , p ←}\end{matrix} ] = {OPE}_{↓ ←} [ \begin{matrix}{E}_{i , s ←} \\ {E}_{i , p ←}\end{matrix} ] \qquad Eq . 5$$

where the left and downward are indicative of light diffracting to the left and down, as at output node 662 of FIG. 6B, and where η is the diffraction efficiency of the transition and ϕ is the phase shift of the transition.

Additionally, each bounce off the AR coating can be described by a 2×2 matrix. In a planar coating, the off-diagonal elements of this matrix are 0, and the magnitude of the diagonal elements must be 1 due to the fact that, in a planar coating, the layers are parallel. Because there is no diffraction from the AR coating, there are only two of these matrices: AR_{⬇⬇} and AR_{←←}.

$${AR}_{↓ ↓} = [ \begin{matrix}{e}^{j {θ}_{s ↓ s ↓}} & 0 \\ 0 & {e}^{j {θ}_{p ↓ p ↓}}\end{matrix} ] \qquad Eq . 6$$

$${AR}_{← ←} = [ \begin{matrix}{e}^{j {θ}_{s ← s ←}} & 0 \\ 0 & {e}^{j {θ}_{p ← p ←}}\end{matrix} ] \qquad Eq . 7$$

The electric field state leaving the output node propagating downward (towards an exit pupil expander) can now be related to the electric field input state.

$$[ \begin{matrix}{E}_{o , s ↓} \\ {E}_{o , p ↓}\end{matrix} ] = ( {OPE}_{↓ ↓} {AR}_{↓ ↓} {OPE}_{↓ ←} {AR}_{← ←} {OPE}_{← ←} + {OPE}_{↓ ←} {AR}_{← ←} {OPE}_{← ↓} {AR}_{↓ ↓} {OPE}_{↓ ←} ) [ \begin{matrix}{E}_{i , s} \\ {E}_{i , p}\end{matrix} ] \qquad Eq . 8$$

However, this may be simplified if the phase retardation (the difference between phase shifts of each of the s and p light paths at each bounce) is 0, such that (θₛ=θₚ). In this case, the anti-reflective coating no longer impacts the energy output. In other words, Eq. 6 and Eq. 7 may be replaced, respectively by:

$${AR}_{↓ ↓} = {e}^{j {θ}_{↓ ↓}} [ \begin{matrix}1 & 0 \\ 0 & 1\end{matrix} ] \qquad Eq . 9$$

$${AR}_{← ←} = {e}^{j {θ}_{← ←}} [ \begin{matrix}1 & 0 \\ 0 & 1\end{matrix} ] \qquad Eq . 10$$

And the output is simplified to:

$$[ \begin{matrix}{E}_{o , s ↓} \\ {E}_{o , p ↓}\end{matrix} ] = {e}^{j {θ}_{↓ ↓}} {e}^{j {θ}_{← ←}} ( {OPE}_{↓ ↓} {OPE}_{↓ ←} {OPE}_{← ←} + {OPE}_{↓ ←} {OPE}_{← ↓} {OPE}_{↓ ←} ) [ \begin{matrix}{E}_{i , s} \\ {E}_{i , p}\end{matrix} ] \qquad Eq . 11$$

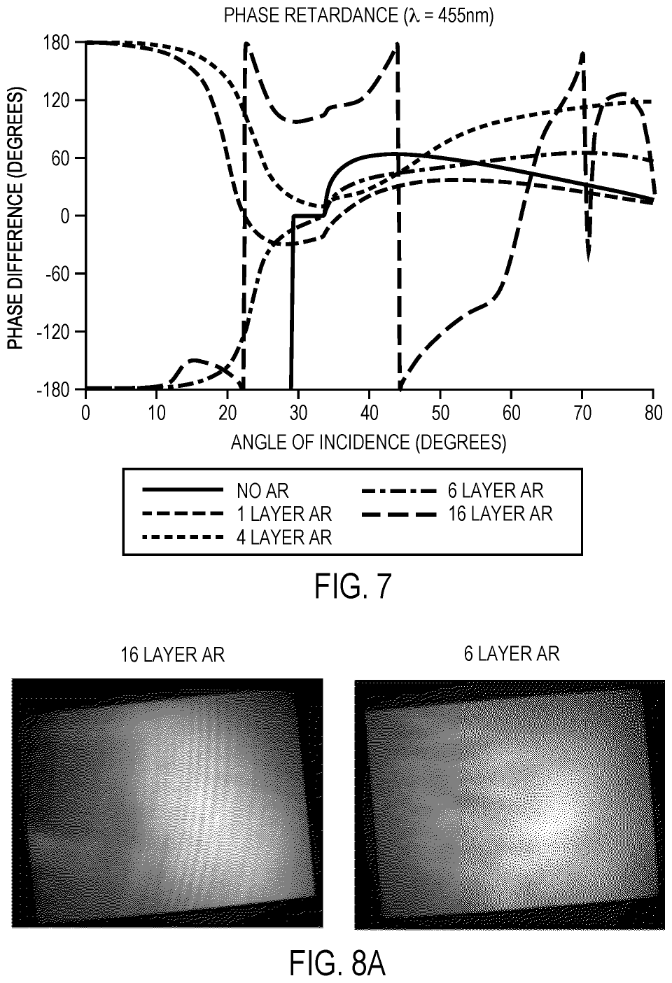

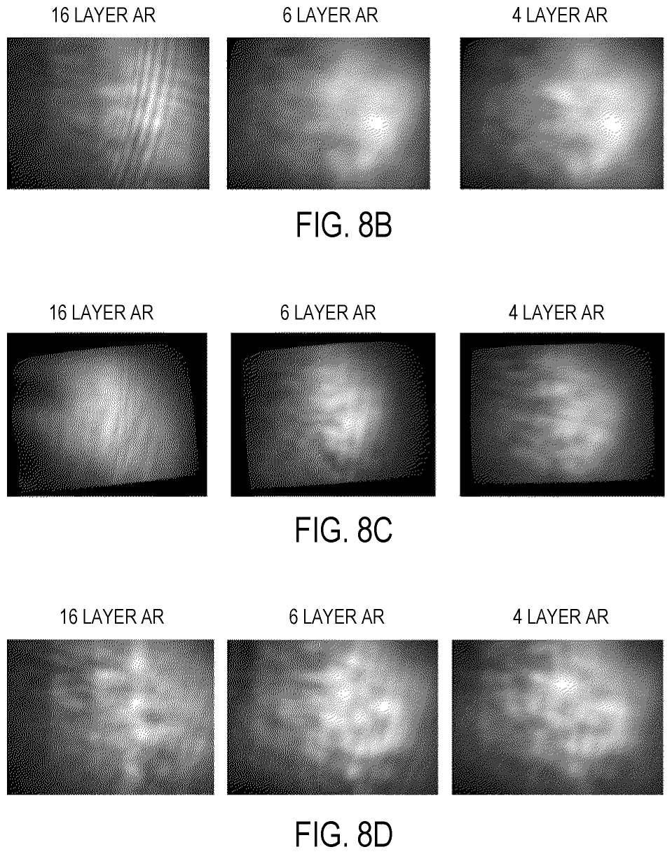

Therefore, if the AR coating has no phase retardation, it only imparts a phase shift to the output, with no change of polarization state or magnitude. If the AR coating does have phase retardation, it will change the output polarization state and magnitude, and introduce negative optical effects. This is critical when determining the number of layers of an anti-reflective coating used on a TIR waveguide display device. FIG. 7 depicts the phase retardation for TIR light at various angles of incidence. FIG. 8A shows captured images of an eyepiece design for blue (455 nm) light on substrates with different n values of layers of an anti-reflective coating. FIG. 8B shows simulated images of an eyepiece design for blue (455 nm) light on substrates with different n values of layers of an anti-reflective coating. FIG. 8C shows captured images of an eyepiece design for red (625 nm) light on substrates with different n values of layers of an anti-reflective coating. FIG. 8D shows simulated images of an eyepiece design for red (625 nm) light on substrates with different n values of layers of an anti-reflective coating. Large variation in phase difference impact the exit beams, observable as “striations” or uniformity disruptions depicted in FIGS. 8A-8D. A four-layer anti-reflective coating is found to have the most uniformity and is thus preferred over the other coatings that are represented in FIGS. 7 and 8A-8D. It will be appreciated that the effects of adjusting the number of anti-reflective layers are consistent across each wavelength, that is, though FIGS. 8A-8D depict eyepieces for particular wavelengths of light the effect is similar for other wavelengths (such as green) that are not shown.

To minimize this degradation and reduce the amount of inter-waveguide reflections while nonetheless maintaining intra-waveguide reflections, embodiments of the present invention are directed to an optimized anti-reflective coating. Such optimization balances the index of refraction of the anti-reflective material with the number and thickness of layers applied in the coating. This will minimize the phase retardation effects by bringing θₛ substantially equal to θₚ.

In some embodiments an anti-reflective coating is applied to one side of a waveguide substrate within a waveguide stack that makes up an eyepiece of an augmented or mixed or virtual reality device. Preferably, the coated side is on the opposing side a viewer's eye is expected to be placed, though a coated side on a same side as a viewer's eye may function similarly. In some embodiments, a grating is applied to the opposite surface of the waveguide as the coated side. The anti-reflective coating preferably reduces reflection from and increases transmission through the surface to which the anti-reflective coating is applied. The anti-reflective coating preferably increases transmission of light to at least 97 percent.

The antireflection coating comprises at least one layer, but in preferred embodiments is less than eight and alternates layers of two alternating constituent materials of comparatively high and comparatively low indices of refraction. In some embodiments, one of the constituent layers is titania (TiO₂). In some embodiments, one of the constituent layers is silica (SiO₂).

One of skill in the art will appreciate other candidate materials, such as SiN, ZrO₂, ZnO₂, Ta₂O₅, or NB₂O₅ or other metal oxides with low absorption in visible wavelength range. Such materials, as with TiO₂ and SiO₂, are well known in the art for their use in the photovoltaic or glass treatment for anti-reflection.

In some embodiments, SiO₂ is a final (i.e. top) layer of a multilayer coating as a protective layer to any wet chemistry (sulfuric acid, hydrogen peroxide, etc.) incident to waveguide cleaning, processing or patterning.

An index of refraction, n, of a material is composed from two elements, the known refractive index and the absorption coefficient k (or imaginary index of refraction that relates to the attenuation of light through the material) such that n=n+ik. Different materials have different absorption coefficients that can produce widely various results, and this is especially variable when multiple materials are layered together to create a net k value for the coating. For example, titania, a well know anti-reflective material, and silicon nitride SiN have similar reflectance spectrums for normal incidence, but slightly different k values. Though these may be negligible in normal/orthogonal light directions, at angles supporting TIR every bounce of the light at a surface is attenuated with a slightly different absorption as compared between the two materials. The cumulative effect of this slight difference of absorption coefficient in a coating that manipulates light across a plurality of bounces in a TIR system can drastically affect the overall image quality, especially uniformity and efficiency.

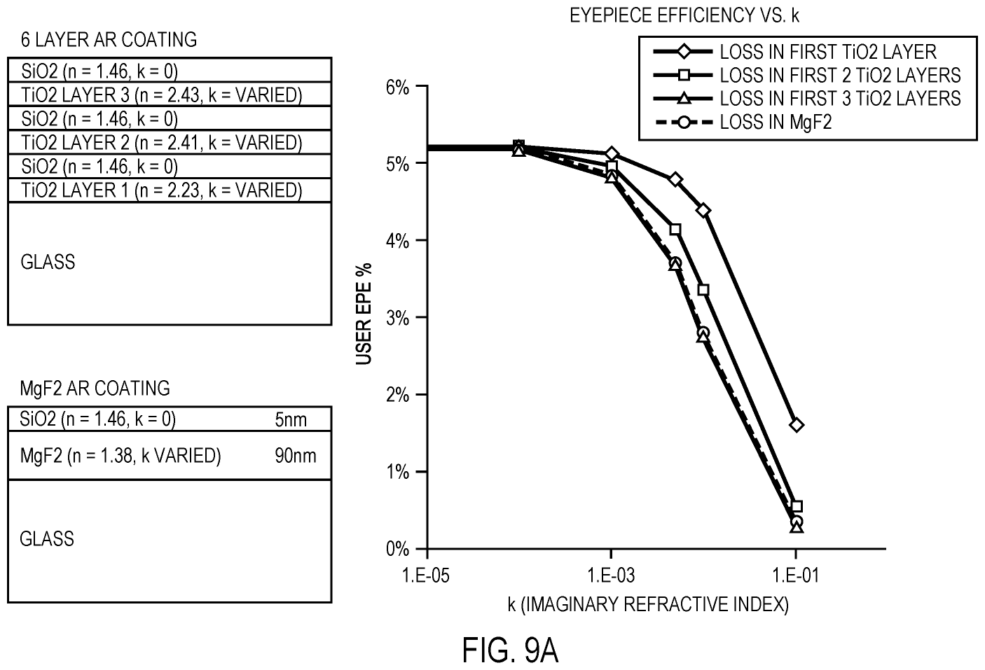

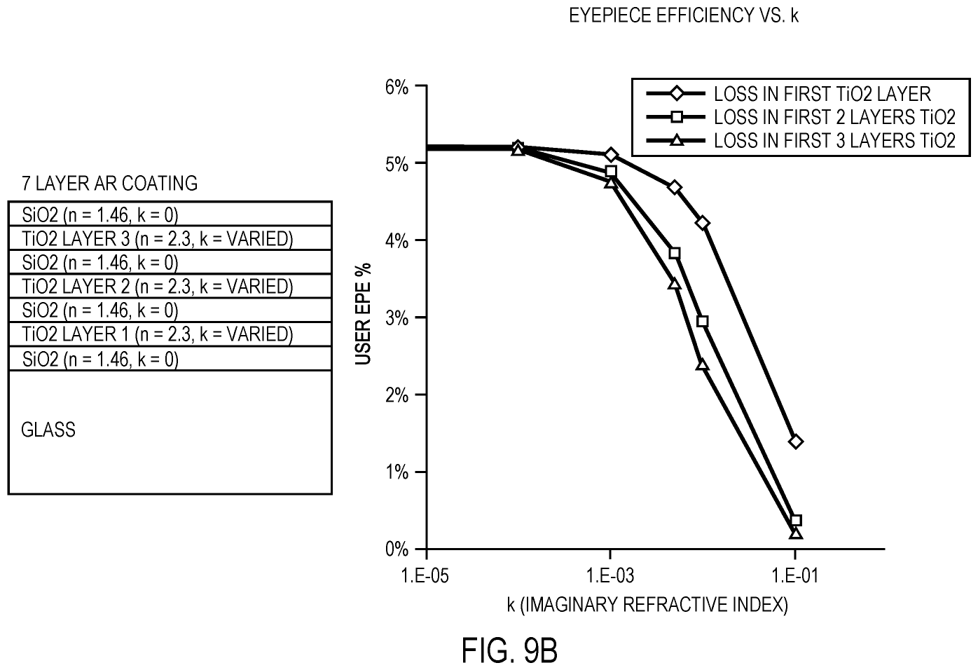

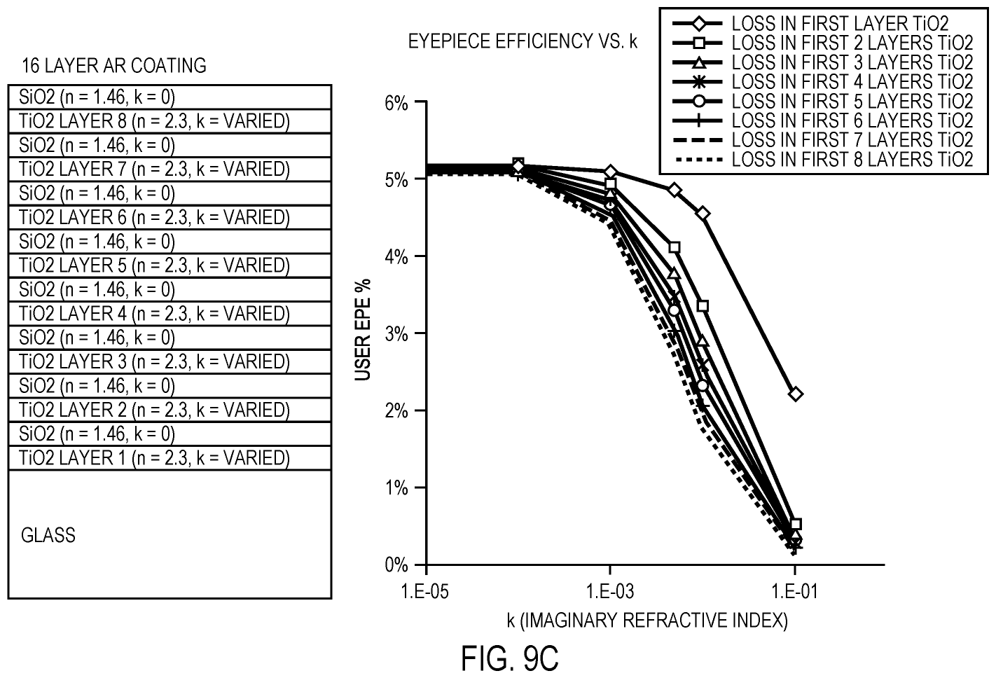

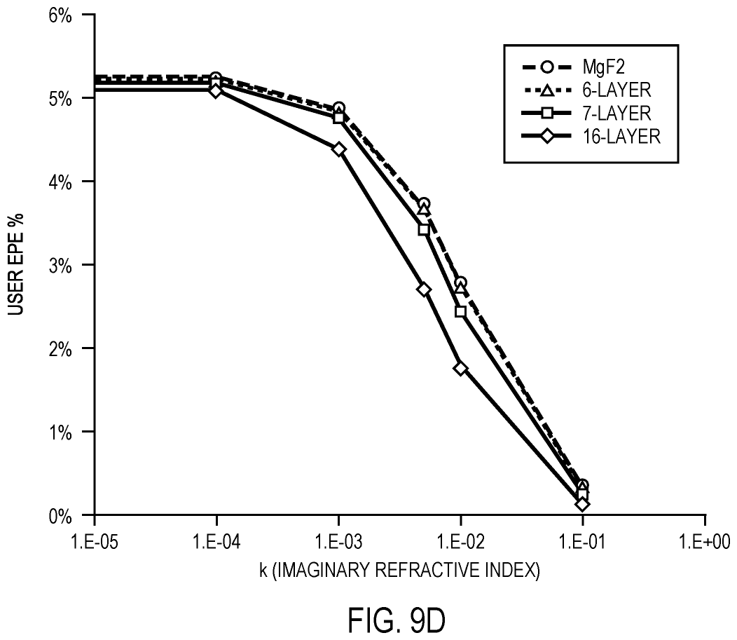

Using the energy output by materials of varying absorption coefficients k of various materials, the loss of light, as a percentage of output, is depicted in FIGS. 9A-9D. FIG. 9A depicts the loss of energy of light output by the EPE as a function of increasing layers and increasing k values. With an exemplary EPE efficiency of five percent as depicted, most single layer anti-reflective coatings preserve this efficiency in a TIR system, such as an optical waveguide, when the net k value is less than approximately 5×10⁻⁴. Each additional layer or increase in net k value exponentially decays the efficiency of the energy output at the EPE. This is true regardless of the material or the number of layers, though the degree of decay changes as shown by FIGS. 9B and 9C.

FIG. 9D depicts an EPE efficiency diagram demonstrating that increased layers, despite any benefits to anti-reflection known in the art, are detrimental to system performance through increased loss.

In some embodiments, anti-reflective coatings with fewer than eight layers are utilized. In some embodiments, such as an MgF₂ coating, only a single layer is utilized.

According to Eq. 1, a target index of refraction may be resolved by simple math, however the cumulative effect of a particular k value is not so easily derived, and in an alternating layer coating the cumulative target n may not be so straightforward either. For example, if a conventional anti-reflective coating material like titania were applied to a glass substrate, Eq.1 would not be satisfied. Glass generally has an index of refraction between 1.5 and 1.6, an anti-reflective coating on glass therefore should have an index of refraction between 1.22 and 1.27. In some embodiments of the present invention, an antireflection coating of MgF₂ is applied (the index of refraction of MgF₂ is 1.38) to a glass substrate.

With reference to FIG. 3, multiple waveguides may be used, such that each waveguide is configured to propagate a particular wavelength of light. A distinct thickness for an anti-reflective coating for each waveguide may be created based on the configured wavelength of that waveguide. For example, in a MgF₂ coating on glass configured to propagate green light (approximately 520 nm), a thickness of 94 nm is desired. Alternatively, a common thickness for any waveguide (to save on manufacturing application complexity) between 75 nm and 125 nm can be applied for single layered coatings to reflect the visible spectrum generally, with the understanding that the exact thickness selected will be more beneficial for the particular wavelength of light dictated by Eq. 2.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Words using the singular or plural number also include the plural and singular number, respectively. Additionally, the words “herein,” “above,” and “below” and words of similar import, when used in this disclosure, shall refer to this disclosure as a whole and not to any particular portions of the disclosure.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

All of the references cited herein are incorporated by reference. Aspects of the disclosure can be modified, if necessary, to employ the systems, functions, and concepts of the above references to provide yet further embodiments of the disclosure. These and other changes can be made to the disclosure in light of the detailed description.

Specific elements of any foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An anti-reflective waveguide, comprising:
a planar waveguide substrate having a first index of refraction;
a plurality of diffractive optical elements disposed upon a first surface of the waveguide; and
an anti-reflective coating disposed upon a second surface of the waveguide, wherein the anti-reflective coating consists of four layers.

2. The anti-reflective waveguide of claim 1, wherein the waveguide is planar and configured to propagate light by total internal reflection between the plurality of diffractive optical elements and the anti-reflective coating in a substantially first direction, and outcouple light in a second direction substantially orthogonal to the first direction.

3. The anti-reflective waveguide of claim 2, wherein the light propagating by total internal reflection comprises an s polarization component and a p polarization component.

4. The anti-reflective waveguide of claim 3, wherein the anti-reflective coating is configured to reduce phase retardation between the two components such that an angle of incidence of the s component is substantially similar to that of the p component through the waveguide.

5. The anti-reflective waveguide of claim 4, wherein the anti-reflective coating reduces reflection from and increases transmission of light through the second surface into the waveguide.

6. The anti-reflective waveguide of claim 5, wherein at least 97 percent of the light is transmitted through the second surface.

7. The anti-reflective waveguide of claim 3, wherein the waveguide substrate is glass and the anti-reflective coating comprises a layer of MgF₂.

8. The anti-reflective waveguide of claim 7, wherein the layer of MgF₂ has a thickness between 75 and 125 nm.

9. The anti-reflective waveguide of claim 7, wherein the anti-reflective coating comprises a layer of SiO₂.

10. The anti-reflective waveguide of claim 8, wherein the layer of MgF₂ is disposed immediately adjacent to the second surface.

11. The anti-reflective waveguide of claim 10, wherein a layer of SiO₂ is disposed upon the layer of MgF₂.

12. The anti-reflective waveguide of claim 11, wherein a cumulative index of refraction of the anti-reflective coating has an imaginary refractive index component value less than 5×10⁻⁴.

13. The anti-reflective waveguide of claim 11, wherein a cumulative index of refraction of the anti-reflective coating has an imaginary refractive index component value between 5×10⁻⁴ and 1×10⁻³.

14. The anti-reflective waveguide of claim 3, wherein the anti-reflective coating is between a first material and a second material.

15. Delete.

16. The anti-reflective waveguide of claim 14, wherein the first material has comparatively higher index of refraction than the second material.

17. The anti-reflective waveguide of claim 14, wherein the first material is TiO₂.

18. The anti-reflective waveguide of claim 14, wherein each layer of TiO₂ has an index of refraction greater than 2.

19. The anti-reflective waveguide of claim 14, wherein the second material is SiO₂.

20. The anti-reflective waveguide of claim 19, wherein each layer of SiO₂ has an index of refraction between 1.45 and 1.58.

21. The anti-reflective waveguide of claim 20, wherein a cumulative index of refraction of the anti-reflective coating has an imaginary refractive index component value less than 5×10⁻⁴.

22. The anti-reflective waveguide of claim 20, wherein a cumulative index of refraction of the anti-reflective coating has an imaginary refractive index component value between 5×10⁻⁴ and 1×10⁻³.

23. The anti-reflective waveguide of claim 1, wherein a cumulative index of refraction of the anti-reflective coating has an imaginary refractive index component value less than 5×10⁻⁴.
